(19) United States
(12) Patent Application Publication
(10) Pub. No.: US 2023/0278098 A1
(43) Pub. Date: Sep. 7, 2023

(54) METHOD FOR DENSIFYING A METAL PART HAVING A COMPLEX SHAPE BY ISOSTATIC PRESSING

(71) Applicants: INSTITUT FRANCO-ALLEMAND DE RECHERCHES DE SAINT-LOUIS, Saint-Louis (FR); UNIVERSITE DE TECHNOLOGIE DE BELFORT-MONTBELIARD, Belfort Cedex (FR)

(72) Inventors: Charles BERNAGE, Montreux Chateau (FR); Christophe VERDY, Evette-Salbert (FR); Sébastien LEMONNIER, Rosenau (FR)

(21) Appl. No.: 18/004,421

(22) PCT Filed: Jul. 1, 2021
(86) PCT No.: PCT/EP2021/068276

§ 371 Date: Jan. 5, 2023

(30) Foreign Application Priority Data
Jul. 21, 2020 (FR) FR2007670

(51) Int. Cl. B22F 3/15; B22F 10/62; B22F 10/64; B22F 10/66; B22F 5/10; B33Y 40/20; B22F 10/28; B22F 3/12

(52) U.S. Cl. CPC B22F 3/15; B22F 10/62; B22F 10/64; B22F 10/66; B22F 5/10; B33Y 40/20; B22F 10/28; B22F 3/1266; B22F 2005/103; B22F 2998/10; B22F 2999/00; B33Y 10/00

(57) ABSTRACT

A method for densifying a metal part, including the following steps: coating the metal part with a leak-tight material, compacting the coated metal part under an isostatic pressure of a fluid, removing the coating from the metal part, and performing final annealing of the metal part.

The present invention relates to a method for densifying a porous metal part.

A particularly beneficial application is in the metallurgical field for the design of metal parts by additive manufacturing.

Generally, methods such as additive manufacturing produce parts that are sometimes very porous (with open porosities and closed porosities). This is the case for certain alloys of aluminium, bronze, gold and especially for copper, the porosity ratio of which is situated between 7 and 20% at the output of a selective laser melting (SLM) machine for example, in particular on account of its high reflectivity. This porosity can affect the final properties of the part, or even cause it to be unsuitable for the application in question (electrical, thermal properties, etc). It is therefore desirable to find a solution making it possible to reduce the porosity of the part while still retaining its shape, which, in the case of parts obtained by additive manufacturing, is generally complex.

One of the solutions consists of combining two processes, the first making it possible to obtain the complex part, and the second making it possible to reduce the final porosity by pressing.

One of the problems for very high-pressure pressing of complex parts produced by additive manufacturing is the presence of hollow portions, internal channels with thin walls, etc.

The conventional method that consists of placing an external envelope around the part, then compressing at several thousand bars is therefore no longer suitable, as it leads to deformation of the parts.

The aim of the present invention is to overcome the aforementioned drawbacks by proposing a new method for densifying the metal part without deformation.

Another aim of the invention is a new densification method making it possible to achieve porosity levels below 1%.

At least one of the objectives of the invention is achieved with a method for densifying a porous metal part comprising the following steps:
coating the metal part with a leak-tight material,
compacting the coated metal part under an isostatic pressure of a fluid,
removing the coating from the metal part, and
final annealing of the metal part.

The metal part used for implementing the method according to the invention as described above can be obtained by additive manufacturing by means of a selective laser melting machine, for example.

The method according to the invention makes it possible to design a metal part having a porosity ratio below 1%, knowing that a selective laser melting machine generates metal parts having a porosity ratio of the order of 10%. Porosity is a parameter associated with the pores present in a solid material. Leak-tightness is associated with the porosity of the material and has a major effect on whether the metal part is leak-tight or not.

The lower the porosity of a material, the better its leak-tightness. This porosity can be measured by analysis of images, by application of Archimedes' principle, or by geometric measurement, determining the dimensions and the weight of the part.

The present invention makes it possible to make metal parts leak-tight for applications where leak-tightness is required.

Compaction makes it possible to apply the method according to the invention to all types of metals, such as copper, aluminium, steel or zinc, with good results in terms of conductivity.

In particular, final annealing makes it possible to greatly improve the conductivity of the metal part. By way of example, the present invention can be implemented in particular in the design of a metal part within an inductor intended to generate a magnetic field. Indeed, for such an application, the importance of conductivity is high. When copper hardened by mixing with 0.1% silver is used, this mixture has a conductivity below that of copper alone. The method according to the invention makes it possible for such an alloy to regain the conductivity of copper.

In particular, coating makes it possible to protect the metal part against the penetration of the fluid during the compacting step. To this end, there are several coating solutions.

According to an advantageous characteristic of the invention, the coating step can comprise placing the metal part in a leak-tight pouch under vacuum. This pouch can be a leak-tight polymer.

According to the invention, the coating step can comprise coating the metal part with a leak-tight metallic material.

Further according to the invention, the coating step can comprise coating the metal part with a resin.

With the leak-tight metallic material and the resin, it is possible to give the assembly a predetermined shape that will facilitate the subsequent compacting step.

Coating makes it possible to protect the metal part and prevent the entry of fluid.

According to an advantageous embodiment of the invention, when the metal part comprises at least one hollow portion, the method according to the invention comprises:
a preliminary step, before coating, of filling said at least one hollow portion with a filler metal that is introduced in liquid form, then solidifying this filler metal, and
a step of removing the filler metal, this step being carried out after removing the coating but before the final annealing.

To remove the solidified filler metal, it is heated to a temperature above its melting point, but below the melting point of the metal part.

By hollow portion is meant any empty space (filled with air, with no material) that would lead to a deformation of the part under isostatic pressing. For example, in a metal part in the shape of an “L”, it can be considered that the space between the vertical bar and the horizontal bar of the “L” constitutes a hollow portion that can be filled before applying the compaction.

A hollow portion is different from a porosity hole.

A method according to the invention makes it possible to carry out compaction without geometric deformation on parts that are hollow, are not hollow, have a fine structure, are of complex geometric shape. By “without geometric deformation” is meant maintaining the initial general shape of the metal part after the step of isostatic pressing. That is to say that the metal part retains its initial overall shape but its dimensions are reduced after pressing. For example, it can be estimated that a maximum pressing making it possible to reduce by 20% the porosity of a metal part will lead to a variation in its volume of the same order of magnitude.

In the case of a hollow part, the method according to the invention can advantageously carry out the compaction without deformation of the recesses of a hollow part, in particular if a filler metal is used the elastic limit of which is both greater than that of the metal of the part treated and greater than that of the isostatic pressure applied. In this case no deformation, whether geometric or dimensional, is observed at the level of the filled recesses.

Filling can be obtained by using a pump to inject the filler metal in liquid form into the hollow portions or also by submerging the complete metal part in a bath of this filler metal in liquid form.

Filling can also consist of giving a predetermined shape to the assembly comprising the metal part and the filler metal, so as to improve efficiency during the coating.

For example, provision can be made, regardless of the initial shape of the metal part, to add the filler metal so as to obtain a round, or other, final shape, allowing for example efficient insertion into a pouch before compacting.

According to an embodiment of the invention, the filler metal can have a melting point below the melting point of the metal part. In this way, removal can be carried out by making the filler metal liquid by heating, without modifying the metal part.

Advantageously, the filler metal can have a melting point below 100 degrees.

According to an advantageous embodiment of the invention, the metal part is made from copper and the filler metal is a tin-based alloy.

This alloy can advantageously be an alloy comprising tin, indium and bismuth. In particular, it can be Field's metal, which is an alloy that liquefies at approximately 62° C. and comprises 32.5% bismuth (Bi), 51% indium (In) and 16.5% tin (Sn).

Such an alloy has the advantage of not adhering too much to the wall of the metal, in particular copper-based, part and of not entering the pores, solidifying at ambient temperature and withstanding high-pressure compaction.

According to an advantageous characteristic of the invention, the compaction can comprise pressurization at an isostatic pressure that is at least 30% greater than the elastic limit of the metal part, preferably greater than 50%.

Preferably, the isostatic pressure is comprised between 2,000 and 10,000 bars.

According to an embodiment, the method according to the invention can comprise a preliminary annealing step carried out before the coating step.

This preliminary annealing step makes it possible to remove any grains, dislocations, etc. that would be present on the surface of the metal part, for improved efficiency of the following steps.

According to the invention, the isostatic pressurizing fluid can be oil, for example in a bath, or a gas.

According to an advantageous characteristic of the invention, the final and/or preliminary annealing can comprise:
a phase of increasing temperature,
a phase of maintaining the metal part at a solubilization temperature, and
a phase of progressive cooling over a duration greater than the duration of the phase of increasing temperature.

The annealing can be carried out in a furnace under vacuum or under neutral atmosphere at 950° for example for copper. This temperature corresponds to a temperature 15-20% below the melting temperature of copper. This is its solubilization temperature.

Advantageously, the final annealing step can be followed by a step of cleaning the metal part, using hydrochloric acid.

Other advantages and characteristics of the invention will become apparent on examining the detailed description of an embodiment that is in no way limitative, and the attached drawings, in which:

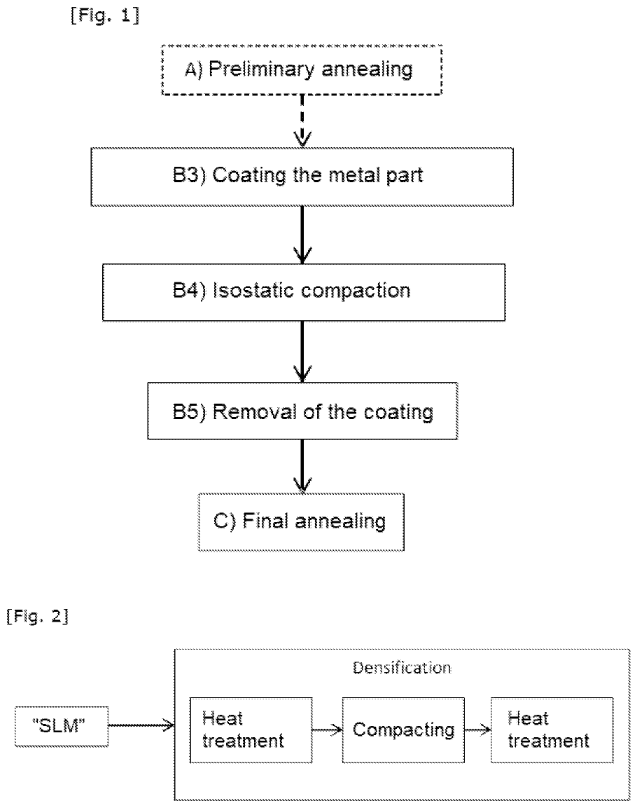

FIG. 1 is a diagram showing the notable steps of the method according to the invention;

FIG. 2 is a diagrammatic view of the processes of design and densification of a metal part;

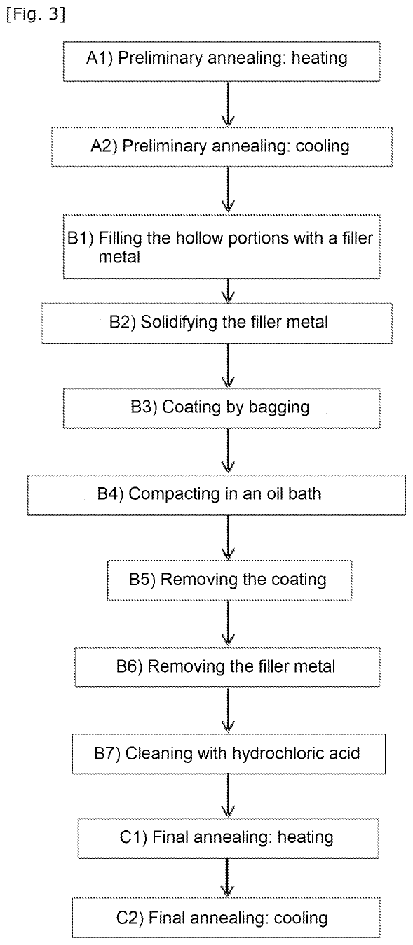

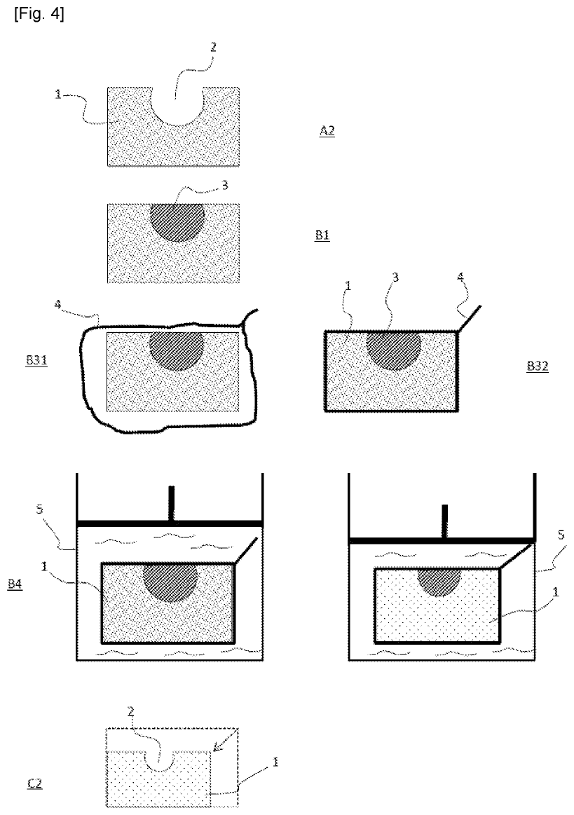

FIG. 3 is a diagram showing a whole set of steps of the method according to the invention;

FIG. 4 is a simplified diagrammatic view showing a metal part in different phases of densification.

The embodiments that will be described below are in no way limitative, variants of the invention can be implemented in particular comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In particular, provision is made for all the variants and all the embodiments described to be combined together in all combinations where there is no objection to this from a technical point of view.

Although the invention is not limited thereto, an embodiment of the method for densifying a metal part based on copper and 0.1% silver will now be described. The invention can be implemented for other types of metals with or without alloying.

In FIG. 1, an optional step of preliminary annealing can be seen, which can be implemented or not. The metal part according to the invention principally undergoes the steps B3, B4, B5 and C as shown in FIG. 1. These steps are described in greater detail below. As a minimum, they make it possible to have a perfectly densified metal part. They can be implemented for solid or hollow metal parts.

FIG. 2 shows a sequence of processes comprising the design of a metal part by means of a selective laser melting (SLM) machine. The metal part thus obtained has a porosity of approximately ten percent.

According to the invention, the densification is implemented by carrying out:
a preliminary heat treatment to prepare the metal part for the following treatment,
a compaction to reduce the porosity,
then a final heat treatment to improve the conductivity of the metal part.

To take account more specifically of the hollow portions that would be present in a metal part, the present invention provides additional steps to maintain the geometric shape of the metal part.

FIG. 3 depicts a set of steps according to the invention. All or part of the steps in the figure contribute to the densification of a metal part while maintaining the geometric shape.

Step A1 relates to an annealing that can be carried out in a furnace under vacuum or in a neutral or inert atmosphere.

For example, the metal part has a complex shape based on copper with 0.1% silver (Cu0.1Ag).

The furnace is used for the annealing at a solution heat treatment temperature of approximately 950° C., which corresponds to a temperature to 20% below the melting temperature of copper. The metal part is placed in the furnace for a period of approximately one hour.

In step A2, the metal part is cooled progressively for approximately 8 to 15 hours before reaching the initial temperature. FIG. 4 shows such a metal part 1 with a high porosity. This part is shown in cross-section. It has a rectangular shape with a hollow portion 2 produced from the upper surface.

In step B1, the hollow portion 2 is filled with a filler metal in its liquid form. This is Field's metal, an alloy of tin having a very low melting point and a low wettability. In FIG. 4, it is noted that the filler metal 3 perfectly occupies all of the hollow portion, so that the assembly constituted by the metal part and the filler metal has a regular shape. The filler metal 3 is flush with the upper surface of the metal part.

In step B2, the filler metal is solidified by allowing it for example to return to ambient temperature, a state in which it is in a solid form.

In step B3, provision is made for a step of coating the metal part by placing it in an envelope of resistant polymer, then by creating a vacuum within the envelope so that the envelope hugs the whole of the metal part. According to the invention, provision is made for other coating methods, such as for example placing a resin or a metal in the form of a container completely enclosing the metal part 1. In particular, the use of bagging may be preferred when the geometric shape of the metal part allows the polymer envelope or pouch to press itself against the whole of the external surface of the metal part when the vacuum is created. A sarcophagus can be produced, in particular using resin, for example when the metal part has a geometric shape that is so complex that bagging would lead to the creation of air pockets when the vacuum is produced or when the metal part includes sharp projections that could pierce the pouch.

In FIG. 4, sub-step B31, the coating method by bagging is noted, i.e. the metal part 1 is placed in an envelope 4 or a pouch made of polymer. In sub-step B32, a vacuum is created in the envelope 4.

In step B4, compacting is carried out by placing the envelope 4 containing the metal part 1 in an oil bath 5, then isostatically compressing under very high pressure at approximately 4,000 bars for several minutes, for example one to 2 minutes. The metal part 1 is then densified and the porosity is reduced until reaching a value below 1%, for example down to 0.35%. Compacting is carried out uniformly in all directions to compress the metal part isostatically. The pressure applied is a function of the physical characteristics of the material constituting the metal part. For example, for copper or for other metals, account is taken of its elasticity. For copper, as its elastic limit value is 200 Mpa, provision is made to apply a pressure of 500 Mpa.

In step B5, the metal part is taken out of the bath and the coating envelope 4 is removed.

In step B6, the filler metal 3 is removed by heating the assembly to a temperature above the melting point of the filler metal but below the melting point of copper.

Step B7 consists of cleaning the metal part thus densified. To this end, hydrochloric acid is used.

In steps C1 and C2, a final annealing is carried out in a manner similar to the preliminary annealing. The objective of this final annealing is to improve the conductivity of the metal part thus densified. In FIG. 4, the final metal part 1 after compacting is noted in C2. Its size is reduced although its geometric shape remains the same. The dotted lines represent its initial size, for example in phase A2. Advantageously the porosity is reduced for example by 20 percent.

With the method according to the invention, the metal part has a leak-tightness and a conductivity comparable to those of the base material. The present invention combines a step of additive manufacturing with a step of isostatic pressing.

Of course, the invention is not limited to the examples which have just been described and numerous adjustments can be made to these examples without exceeding the scope of the invention.

1. A method for densifying a porous metal part comprising at least one hollow portion, the method comprising the following steps:
a preliminary step of filling said at least one hollow portion with a filler metal that is introduced in liquid form, then solidifying this filler metal, the filler metal having a melting point below the melting point of the metal part;
coating the metal part with a leak-tight material;
compacting the coated metal part under an isostatic pressure of a fluid;
removing the coating from the metal part;
removing the filler metal, and; and
final annealing of the metal part.

2. The method according to claim 1, characterized in that the coating step comprises placing the metal part in a leak-tight pouch under vacuum.

3. The method according to claim 1, characterized in that the coating step comprises coating the metal part with a leak-tight metallic material.

4. The method according to claim 1, characterized in that the coating step comprises coating the metal part with a resin.

5. The method according to claim 1, characterized in that the filler metal has a melting point below 100 degrees C.

6. The method according to claim 1, characterized in that the metal part is made from copper and the filler metal is a tin-based alloy.

7. The method according to claim 1, characterized in that the compacting comprises pressurization an isostatic pressure that is at least 30% greater than the elastic limit pressure of the metal part.

8. The method according to claim 7, characterized in that the isostatic pressure is comprised between 2,000 and 10,000 bars.

9. The method according to claim 1, characterized in that it comprises a preliminary annealing step carried out before the coating step.

10. The method according to claim 1, characterized in that the isostatic pressurizing fluid is oil.

11. The method according to claim 1, characterized in that the isostatic pressurizing fluid is a gas.

12. The method according to claim 1, characterized in that the final and/or preliminary annealing comprises a phase of increasing temperature, a phase of maintaining the metal part at a solubilization temperature, and a phase of progressive cooling over a duration greater than the duration of the phase of increasing temperature.

13. The method according to claim 1, characterized in that the step of final annealing is followed by a step of cleaning by using hydrochloric acid.
